(19) United States
(12) Patent Application Publication
(10) Pub. No.: US 2026/0035601 A1
(43) Pub. Date: Feb. 5, 2026

(54) HOT-MELT PRESSURE-SENSITIVE ADHESIVES FOR RESEALABLE PACKAGING

(71) Applicant: Bostik SA, COLOMBES (FR)

(72) Inventors: Christophe ROBERT, VENETTE (FR); Barbara WIEGERT, COLOMBES (FR)

(21) Appl. No.: 18/997,199

(22) PCT Filed: Jul. 24, 2023
(86) PCT No.: PCT/FR2023/051149

§ 371 Date: Jan. 21, 2025

(30) Foreign Application Priority Data
Jul. 27, 2022 (FR) FR2207723
Sep. 8, 2022 (FR) FR2208976

(51) Int. Cl. C09J 123/20; B32B 7/12; B32B 27/08; B65D 65/40; C08J 5/12; C09J 11/08

(52) U.S. Cl. CPC C09J 123/20; B32B 7/12; B32B 27/08; B65D 65/40; C08J 5/128; C09J 11/08; B32B 2250/05; B32B 2439/70; C08J 2423/20

(57) ABSTRACT

The present invention relates to a hot-melt self-adhesive composition comprising:
i) from 40% to 80% by weight of at least one but-1-ene-ethylene copolymer A, said copolymer comprising more than 80% by weight of units derived from but-1-ene;
ii) from 1.5% to 4.5% by weight of at least one propylene-ethylene-butene copolymer T, said copolymer T comprising more than 50% by weight of units derived from propylene;
iii) at least one nonhydrogenated tackifying resin obtained by polymerization, or copolymerization with an aromatic hydrocarbon, of mixtures of unsaturated aliphatic hydrocarbons having from 4 to 6 carbon atoms resulting from petroleum cuts.

### FIELD OF THE INVENTION

A subject matter of the present invention is a novel hot-melt self-adhesive composition, and also a multilayer film intended for the manufacture of reclosable packagings (or trays), which comprises an adhesive layer consisting of said composition.

### TECHNOLOGICAL BACKGROUND

Reclosable trays are used in the food-processing industry and mass marketing to package foodstuffs, in particular fresh products. Such packagings are described by the patent U.S. Pat. No. 4,673,601 and the patent application EP 1 053 952.

After the packaging has been opened for the first time and a part of the food product which it contains has been consumed, the consumer can manually reclose the packaging in a substantially hermetic manner and can consequently, if appropriate after placing it in a refrigerator, preserve the remaining portion of the product. A sequence of reopenings and of reclosings is also possible.

These packagings generally comprise a container (or receptacle) and a cover forming a lid, which are hermetically attached to each other by welding.

The more or less deep and relatively rigid receptacle consists of a multilayer (also referred to as complex or composite) sheet having a minimum thickness of 200 μm, in general of between 200 and 1000 μm. This sheet is thermoformed so as to exhibit a flat bottom, on which the food product rests, and a perimeter in the form of a flat band. This perimeter, which is generally parallel to the bottom, is bonded by welding to the flexible and flat cover, which consists of a multilayer (also described as complex or composite) film with a thickness generally between 40 and 150 μm, and which is sometimes denoted by the name “lidding film”.

During the opening of the packaging, the lidding film is manually separated from the receptacle at the flat band of the perimeter. This operation reveals an adhesive layer at the level of this flat band, both on the cover band and on the receptacle band which were previously in contact. These two (continuous or noncontinuous) adhesive layers, referred to as “daughter” layers, result from the rupturing of an initial or “mother” adhesive layer or, possibly, from its separation (or detachment) from one of the two layers of the complex multilayer film which are adjacent to it. The initial adhesive layer is thus one of the layers of said complex multilayer film which is itself an element included either in the composite sheet which constitutes the receptacle or, possibly, in the lidding film.

The two daughter adhesive layers which are present, after the packaging has been opened, on the bands located on the respective perimeters of the receptacle and of the cover, are thus facing each other. Thus, it suffices to reposition the cover on the receptacle, in accordance with their position in the packaging before opening, in order to bring the two bands of daughter adhesive layers back into contact. Simple manual pressure then makes it possible to obtain reclosing of the packaging.

The adhesive composition which constitutes the mother and daughter adhesive layers is thus necessarily a pressure-sensitive adhesive or PSA (also called self-adhesive composition).

The hot-melt self-adhesive compositions typically comprise tackifying resins and styrene block copolymers including an elastomer block. The hot-melt adhesive compositions are also commonly referred to as HMPSAs, corresponding to the initials of the term “Hot-Melt Pressure-Sensitive Adhesive”. These are substances which are solid at ambient temperature and which contain neither water nor solvent. Applied in the molten state, they solidify as they cool, thus forming an adhesive layer which provides the bonding between the two thin layers of thermoplastic polymeric material to be assembled, while providing the corresponding packaging with the advantageous opening and reclosing properties.

A “stick-slip” phenomenon (commonly known as “stick-slip”) may be observed during the peeling of the adhesive while opening the packaging. This jerky movement, which creates jolts, generates an unpleasant sensation for the consumer, who prefers a smooth and uniform opening of the packaging. The quality of the rupture of the adhesive is thus an important parameter which impacts the feelings of the consumer.

There thus exists a need for a hot-melt self-adhesive composition which make it possible to at least partially overcome at least one of the abovementioned disadvantages.

There exists in particular a need for a hot-melt self-adhesive composition exhibiting a good compromise between adhesive properties and quality of the rupture. In particular, there exists a need for a hot-melt self-adhesive composition exhibiting a good compromise between a sufficient first opening strength, a maximum reclosing strength and good quality of the adhesive rupture.

### DESCRIPTION OF THE INVENTION

### Composition

The present invention relates to a hot-melt self-adhesive composition comprising:
i) from 40% to 80% by weight of at least one but-1-ene-ethylene copolymer A, said copolymer comprising more than 80% by weight of units derived from but-1-ene;
ii) from 1.5% to 4.5% by weight of at least one propylene-ethylene-butene copolymer T, said copolymer T comprising more than 50% by weight of units derived from propylene;
iii) at least one nonhydrogenated tackifying resin obtained by polymerization, or copolymerization with an aromatic hydrocarbon, of mixtures of unsaturated aliphatic hydrocarbons having from 4 to 6 carbon atoms resulting from petroleum cuts.

The percentages by weight of the ingredients are with respect to the total weight of said hot-melt self-adhesive composition.

In the context of the present invention, the term “copolymer” refers to a polymer obtained by the polymerization of at least two different monomers. The term “copolymer” includes terpolymers which comprise three different types of monomers.

Unless otherwise indicated, the standards mentioned throughout the patent application are those in force at the date of filing of the patent application.

### Copolymer A

The hot-melt self-adhesive composition preferably comprises from 45% to 80% by weight of copolymer(s) A, more preferentially still from 50% to 80% by weight, with respect to the total weight of said composition. More preferably still, the composition comprises from 50% to 70% by weight of copolymer(s) A, with respect to the total weight of said composition.

The copolymer A can have a lower density ranging from 0.800 to 0.899 g/cm³, preferably from 0.850 to 0.895 g/cm³ and more preferentially still from 0.860 to 0.880 g/cm³.

The density can be measured according to the standard ISO 1183-1.

The copolymer A can have a Shore A hardness of less than or equal to 90, preferably of less than or equal to 70 and more preferentially still of less than or equal to 65.

The Shore A hardness can be measured according to the standard ISO 868.

The copolymer A can have a polydispersity index (M_{w}/Mₙ) of less than or equal to 3, preferably ranging from 2 to 3.

The polydispersity index can be measured by size exclusion chromatography (SEC), for example using a standard of polystyrene type.

The copolymer A preferably comprises more than 82% by weight of units derived from but-1-ene and more preferentially still more than 90% by weight of units derived from but-1-ene.

The copolymer A can comprise at most 20% by weight of units derived from ethylene, preferably at most 18% by weight of units derived from ethylene and more preferentially still at most 10% by weight of units derived from ethylene.

The percentages by weight of monomer units are with respect to the total weight of said copolymer A.

The percentage by weight of monomer units can be determined by any known method, such as, for example, by NMR.

The copolymer A is preferably obtained by polymerization in the presence of catalysts of metallocene type which are well known in the field.

The copolymer A can also be commercially available. Mention may be made, for example, of the polymer Koattro@ KT MR06 sold by LyondellBasell, which is a C₂/C₄ copolymer having an MFI at 190° C., 2.16 kg, of 1.3 g/10 min and comprising a C₂ ethylene content by weight of approximately 8.3%.

### Copolymer T

The hot-melt self-adhesive composition preferably comprises from 1.8% to 4.3% by weight of copolymer(s) T, preferentially from 2.0% to 4.0% and more preferentially still from 2.0% to 3.5% by weight, with respect to the total weight of said composition.

The copolymer T can be obtained by polymerization in the presence of a catalyst of metallocene or Ziegler-Natta type which are well known in the field.

A copolymer T can also be commercially available, such as Adsyl® 7622 XCP sold by LyondellBasell comprising more than 50% by weight of units derived from propylene and having a melting point of 132° C. and also an MFI at 230° C., 2.16 kg, of 5.6 g/10 min.

The copolymer T preferably comprises more than 60% by weight of units derived from propylene, more preferentially more than 70% by weight of units derived from propylene and more preferentially still more than 80% by weight of units derived from propylene.

The copolymer T can comprise from 1% to 25% by weight of units derived from ethylene, preferably from 1% to 10% by weight of units derived from ethylene and more preferentially still from 1% to 5% by weight of units derived from ethylene.

The copolymer T can comprise from 1% to 25% by weight of units derived from butene, preferably from 2% to 15% by weight of units derived from butene and more preferentially still from 5% to 12% by weight of units derived from butene.

The percentages by weight of monomer units are with respect to the total weight of said copolymer T.

The percentage by weight of monomer units can be determined by any known method, such as, for example, by NMR.

The copolymer T is preferably crystalline.

The copolymer T preferably has a melting point, measured by DSC (Differential Scanning calorimetry), ranging from 130° C. to 160° C.

The copolymer T preferably has a melt flow index (MFI) ranging from 0.6 to 10 g/10 min, preferably from 2 to 10 g/10 min and more preferentially still from 4 to 8 g/10 min.

The melt flow index (MFI) of the copolymer T is measured at 230° C. and under a total weight of 2.16 kg, in accordance with condition d) of the standard ISO 1133. The MFI is the weight of composition (placed beforehand in a vertical cylinder) which flows in 10 minutes through a die with a fixed diameter, under the effect of a pressure exerted by a laden piston having the total weight of 2.16 kg.

Tackifying Resin iii)

The hot-melt self-adhesive composition according to the invention comprises at least one nonhydrogenated tackifying resin iii) obtained by polymerization (or copolymerization with an aromatic hydrocarbon) of mixtures of unsaturated aliphatic hydrocarbons having from 4 to 6 carbon atoms (preferably approximately 5 carbon atoms) resulting from petroleum cuts.

When the tackifying resin is obtained by copolymerization of mixtures of unsaturated aliphatic hydrocarbons having from 4 to 6 carbon atoms with an aromatic hydrocarbon, it is a matter in particular of aromatic-modified aliphatic resins. It is well known to a person skilled in the art that the content of aliphatic radicals is greater than that of aromatic radicals in aromatic- modified aliphatic resins.

Preferably, the nonhydrogenated tackifying resin iii) is obtained by polymerization of mixtures of unsaturated aliphatic hydrocarbons having from 4 to 6 carbon atoms resulting from petroleum cuts.

The tackifying resin iii) can have a softening temperature (or point) ranging from 25° C. to 150° C., preferably from 30° C. to 130° C., more preferentially from 50° C. to 120° C. and more preferentially still from 90° C. to 120° C.

The softening temperature is determined in accordance with the standardized test ASTM E 28, the principle of which is as follows. A brass ring with a diameter of approximately 2 cm is filled with the resin to be tested in the molten state. After cooling to ambient temperature, the ring and the solid resin are placed horizontally in a thermostatically controlled bath of glycerol, the temperature of which can vary by 5° C. per minute. A steel ball with a diameter of approximately 9.5 mm is centered on the disk of solid resin. The softening temperature is the temperature, during the phase of rise in temperature of the bath at the rate of 5° C. per minute, at which the disk of resin yields by a height of 25.4 mm under the weight of the ball.

The tackifying resin iii) can have a weight-average molar mass M_{w} generally of between 300 and 5000 Da, preferably between 1000 and 2000 Da.

Mention may be made, among the tackifying resins iii), for example, of Escorez® 1310LC sold by ExxonMobil Chemical (softening temperature of 94° C. and an M_{w} of approximately 1800 Da) or also of Wingtack@ 98 sold by Cray Valley (softening temperature of 98° C. and an M_{w} of approximately 2000 Da).

The composition according to the invention can comprise a total content of tackifying resin(s) iii) ranging from 18.5% to 58.5% by weight, preferably from 18.5% to 53.5% by weight, preferentially from 18.5% to 48.5% by weight and more preferentially still from 28.5% to 48.5% by weight, with respect to the total weight of said composition.

The hot-melt self-adhesive composition can comprise a tackifying resin iii) as defined above or a mixture of tackifying resins iii) as defined above.

Optional Tackifying Resin iv) The hot-melt self-adhesive composition can also comprise, in addition, one or more tackifying resin(s) iv) different from the resin iii) as defined above.

The tackifying resin iv) can be chosen from those having a weight-average molar mass M_{w} of between 300 and 5000 Da.

The tackifying resin(s) iv) can be chosen in particular from:
iv-a) rosins of natural origin or modified rosins, such as, for example, the rosin extracted from pine gum, wood rosin extracted from tree roots and their derivatives which are hydrogenated, dehydrogenated, dimerized, polymerized or esterified with monoalcohols or polyols, such as glycerol;
iv-b) resins obtained by hydrogenation, polymerization or copolymerization (with an aromatic hydrocarbon) of mixtures of unsaturated aliphatic hydrocarbons having approximately 9 or 10 carbon atoms resulting from petroleum cuts. Mention may be made, among the tackifying resins iv-a), for example, of Sylvalite® RE 100S from Kraton Polymers (ester of rosin and of pentaerythritol having a softening temperature of approximately 100° C.).

Mention may be made, among the tackifying resins iv-b), for example, of Escorez® 5400 sold by ExxonMobil Chemical, which is a resin obtained by polymerization and then hydrogenation of a mixture of unsaturated aliphatic hydrocarbons having approximately 9 or 10 carbon atoms and which has a softening temperature of 100° C. and an Mw of approximately 570 Da.

Preferably, the hot-melt self-adhesive composition of the invention does not comprise a tackifying resin chosen from terpene resins.

Terpene resins cover in particular unmodified terpene resins, terpene resins modified by the action of phenols (terpene-phenol resins) and also terpene resins resulting from copolymerization (for example styrene/terpene). The terpene resins can result from the polymerization of terpene hydrocarbons, such as, for example, monoterpene (or pinene), in the presence in particular of Friedel-Crafts catalysts. Known in particular among the terpene resins are Dercolyte@ S115 available from DRT (terpene resin having a softening temperature of 115° C. and an Mw of approximately 2300 Da) or also Sylvares@ TR7115 from Kraton Polymers.

According to a preferred embodiment, the composition according to the invention does not comprise a tackifying resin other than the abovementioned tackifying resin(s) iii).

According to a preferred embodiment, the hot-melt self-adhesive composition does not comprise hydrogenated Cg aromatic resins.

### Additional/Optional Components

Preferably, the hot-melt self-adhesive composition according to the invention comprises less than 0.1% by weight of styrene block copolymer (SBC), more preferentially still less than 0.05% by weight, with respect to the total weight of said composition. More advantageously still, the hot-melt self-adhesive composition does not comprise styrene block copolymer.

The styrene block copolymers consist of blocks of various polymerized monomers including at least one polystyrene block, and are typically prepared by radical polymerization techniques.

According to one embodiment, the abovementioned hot-melt self-adhesive composition consists of:
i) from 45% to 80% by weight of at least one copolymer A as defined above;
ii) from 1.5% to 4.5% by weight of at least one copolymer T as defined above;
iii) at least one nonhydrogenated tackifying resin obtained by polymerization, or copolymerization with an aromatic hydrocarbon, of mixtures of unsaturated aliphatic hydrocarbons having from 4 to 6 carbon atoms resulting from petroleum cuts;
from 0% to 5% by weight of additional component chosen from the group consisting of stabilizers (antioxidants), plasticizers, anticaking agents, pigments, dyes, organic fillers, inorganic fillers and their mixtures.

The total amount of additional component(s) can range from 0.01% to 2% by weight, preferably from 0.1% to 2% by weight, with respect to the total weight of said composition.

The antioxidants can typically be introduced in order to protect the composition from degradation resulting from a reaction with oxygen which is liable to be formed by the action of heat, light or residual catalysts on certain starting materials, such as the tackifying resins. These compounds can include primary antioxidants, which trap free radicals and are generally substituted phenols, such as Irganox® 1010 from BASF. The primary antioxidants can be used alone or in combination with other antioxidants, such as phosphites, for instance Irgafos® 168, also from BASF, or also with UV stabilizers, such as amines.

The anticaking agents can be chosen from talc, calcium carbonate, calcium stearate, silica (natural or synthetic) or their mixtures.

Use may be made, as plasticizer, of a paraffinic and naphthenic oil (such as Primol® 352 from ExxonMobil) optionally comprising aromatic compounds (such as Nyflex@ 222B).

According to a preferred embodiment, the abovementioned hot-melt self-adhesive composition comprises:
i) from 45% to 80% by weight of at least one copolymer A as defined above;
ii) from 2.0% to 4.0% by weight of at least one copolymer T as defined above;
iii) at least one nonhydrogenated tackifying resin obtained by polymerization, or copolymerization with an aromatic hydrocarbon, of mixtures of unsaturated aliphatic hydrocarbons having from 4 to 6 carbon atoms resulting from petroleum cuts;
from 0% to 5% by weight of additional component chosen from the group consisting of stabilizers (antioxidants), plasticizers, anticaking agents, pigments, dyes, organic fillers, inorganic fillers and their mixtures.

### Composition

The hot-melt self-adhesive composition can have a total content of polymers (copolymer A+copolymer T) ranging from 41.5% to 84.5%, preferably from 46.8% to 84.3%, more preferentially from 52% to 84% and more preferentially still from 52% to 73.5%.

The hot-melt self-adhesive composition can comprise a polymers (copolymer A+copolymer T): tackifying resin(s) iii) ratio by weight ranging from 40:60 to 90:10, preferably from 45:55 to 85:15 and more preferentially still from 50:50 to 70:30.

The hot-melt self-adhesive composition according to the invention can have a melt flow index (MFI) ranging from 5 to 50 g/10 min, preferably from 5 to 20 g/10 min and more preferentially still from 5 to 15 g/10 min.

The melt flow index (MFI) of the hot-melt self-adhesive composition is measured at 190° C. and under a total weight of 2.16 kg, in accordance with condition d) of the standard ISO 1133. The MFI is the weight of composition (placed beforehand in a vertical cylinder) which flows in 10 minutes through a die with a fixed diameter, under the effect of a pressure exerted by a laden piston having the total weight of 2.16 kg. Unless otherwise mentioned, the MFI values indicated in the present text were measured under these same conditions.

The hot-melt self-adhesive composition according to the invention is preferably provided in the form of granules of ellipsoidal shape, the mean dimensions of the major axis and of the minor axis of which are advantageously as follows:
mean dimension of the major axis of between 1 and 10 mm, preferably between 2 and 6 mm;
mean dimension of the minor axis of between 1 and 10 mm, preferably between 2 and 6 mm.

The mean dimensions are typically calculated by taking the mean over ten measurements.

The dimensions of the major axis and of the minor axis of the granules can be measured using a sliding caliper.

The hot-melt self-adhesive composition can be prepared in this form by a process which comprises:
a stage of hot mixing of the ingredients, between 150° C. and 220° C., by means of a twin-screw extruder equipped with a tool for cutting the extruded product of the underwater cutting type at the outlet of the die, then
a stage of drying and cooling, for example to ambient temperature (23° C.).

The process can comprise a stage of hot premixing of the copolymers A and T as defined above, then said stage of hot mixing of the ingredients (of the premix with the other ingredients, such as, for example, the tackifying resin) between 150° C. and 250° C., by means of a twin-screw extruder equipped with a tool for cutting the extruded product of the underwater cutting type at the outlet of the die.

### Multilayer Films

The present invention also relates to a multilayer film comprising two thin layers B and C of thermoplastic material bonded together by an adhesive layer A, characterized in that said layer A consists of the hot-melt self-adhesive composition as defined above.

The adhesive layer A preferably provides the bonding between a thin laminatable layer B and a thin sealable and breakable layer C.

The thickness of the adhesive layer A can be of between 7 and 50 μm, preferably of between 7 and 35 μm and more preferentially still of between 7 and 25 μm.

The laminatable layer B can be laminated with other layers for the preparation of the packaging, for example with a rigid layer for the preparation of the receptacle.

The sealable and breakable layer C makes it possible to ensure, at the level of the periphery along which the receptacle is bonded by welding to the cover, the first opening of the packaging, by means of a breakable weakened area. After opening, the weakened area reveals:
the mother adhesive layer on the cover band and/or on the receptacle band which were in contact in the closed packaging, and/or
two daughter adhesive layers resulting from the rupture of the mother adhesive layer and which are located on the cover band and/or the receptacle band.

The material which can be used to form the two layers B and C can be a thermoplastic polymer (identical or different for the two layers), such as:
polyethylene (PE),
polypropylene (PP),
a copolymer based on ethylene and on propylene,
polyamide (PA),
polyethylene terephthalate (PET), or also
a copolymer based on ethylene, such as, for example, a maleic anhydride-grafted copolymer, a copolymer of ethylene and of vinyl acetate (EVA), a copolymer of ethylene and of vinyl alcohol (EVOH), a copolymer of ethylene and of an alkyl acrylate, such as methyl acrylate (EMA) or butyl acrylate (EBA),
polystyrene (PS),
polyvinyl chloride (PVC),
polyvinylidene fluoride (PVDF),
a lactic acid polymer (PLA), or
a polyhydroxyalkanoate (PHA).

The term “copolymer” corresponds to a polymer obtained by polymerization of at least two different monomers. The term “copolymer” includes in particular terpolymers.

A polyolefinic material, and very particularly PE, and more preferentially still a low-density PE (LDPE), is preferably used to form the two layers B and C.

The thickness of the layers B and C can vary within a wide range extending from 5 to 150 μm.

The multilayer film according to the invention can comprise, in addition to the layers A, B and C, one or more additional layers. It can be a matter, for example, of bonding layers, or layers having a barrier effect (for example against oxygen, water vapor or carbon monoxide), or also layers making possible an improved mechanical strength.

These additional layers can be connected to the adhesive layer directly, or can be between a layer B (or C) and another additional layer.

The bonding layers are also denoted by the name “intermediate layers” or by the term “tie layers” and generally have a thickness of between 1 and 10 μm, preferably between 2 and 8 μm. The use of such bonding layers advantageously makes it possible to improve the quality of the reclosing of the multilayer film, and thus of the corresponding reclosable packaging, thus more effectively providing the consumer with the preservation of the remaining portion of the perishable food product contained in the packaging, after the first opening of the latter.

The bonding layers advantageously consist of identical or different compositions having a melting point of approximately 80° C. to 160° C. and essentially comprising polymers chosen from homopolymers or copolymers of ethylene, homopolymers or copolymers of propylene, copolymers of ethylene with a polar comonomer, and homopolymers or copolymers of olefins grafted (for example, olefins grafted with maleic anhydride). Reference is made, for further details on these compositions, to the patent application US2013/0029553.

The layers having a barrier effect can be based on ethylene and vinyl alcohol copolymer EVOH.

The layers making possible an improved mechanical strength can be based on polyamide (PA), PVDF and their mixtures.

The multilayer film according to the invention can comprise, besides the three essential layers A, B and C, and additional optional layers, other thin layers necessary for the preparation of the packaging, such as, for example:
a rigid layer necessary for the mechanical strength of the receptacle, or
a printable layer.

The materials which can be used to form said layers can be identical or different and generally comprise thermoplastic polymers which can be chosen from the polymers mentioned above for the layers B and C.

According to an alternative implementational example, the multilayer film according to the invention is a film comprising three layers consisting of the adhesive layer A and the two layers B and C, according to the sequence B/A/C in which the “/” sign signifies that the faces of the layers in question are in direct contact.

According to another alternative implementational example, the multilayer film according to the invention is a film comprising five layers consisting of the adhesive layer A, two additional layers D and E and two external layers B and C, according to the sequence B/D/A/E/C in which the “/” sign signifies that the faces of the layers in question are in direct contact.

According to another alternative implementational example, the multilayer film according to the invention is a film at least six layers comprising the adhesive layer A, the additional layers D and E, a thin layer F and the two external layers B and C, according to the sequence B/D/F/E/A/C.

The present invention also relates to a process for the manufacture of the multilayer film as defined above, characterized in that it comprises a stage of coextrusion of the hot-melt self-adhesive composition and of the constituent materials of the layers B and C and, if appropriate, of the additional layers.

Preferably, the compositions and constituent materials of the layers A, B, C and, if appropriate, D and E are fed into the coextrusion device in the form of granules with the abovementioned dimensions. Thus, the hot-melt self-adhesive composition employed in the multilayer film according to the invention makes it possible, in a particularly advantageous way, to provide both the properties required for said film and the possibility of a presentation of said adhesive composition in the form of the abovementioned granules. The other layers possibly included in the multilayer film can be obtained either by the incorporation, in the coextrusion device, of the corresponding constituent materials in the form of granules of the same size (such as, for example, for the additional layers D and E) or by a process of laminating the film directly resulting from the coextrusion, for example employing a polyurethane-based adhesive.

The coextrusion device employed in the manufacturing process is preferably a bubble blowing coextrusion device (also known under the name “blown film coextrusion device”). In a way known to a person skilled in the art, this process comprises:
the melting, in separate extruders, of the compositions and constituent materials of the layers A, B and C, and also, if appropriate, D and E, then
the passing of the corresponding streams through an assembly of annular and concentric dies, so as to form a tubular bubble comprising several layers, in the order corresponding to that desired for the final structure, then
the radial expansion (relative to the annular die) and the drawing (in the axial direction) of the bubble, then
the cooling of the bubble.

The geometrical characteristics of the dies, as well as the parameters of the process, such as the degree of radial expansion and the drawing rate, are set so as to obtain the thicknesses desired for the various constituent layers of the multilayer film. Reference is made in particular, for a fuller description of the bubble blowing coextrusion process, to the patent application US2013/0029553.

The hot-melt self-adhesive composition according to the invention advantageously exhibits a good compromise between adhesive properties and good quality of the rupture. In particular, the hot-melt self-adhesive composition advantageously exhibits a good compromise between:
a sufficient first opening strength (preferably less than or equal to 5 N/cm, more preferentially still less than or equal to 4.8 N/cm),
a maximum reclosing strength, in particular a maximum fifth opening strength (for example, greater than or equal to 0.6 N/cm), and
a good quality of the rupture (reduced stick-slip phenomenon).

### Uses

The present invention also relates to the use of the multilayer film as described above for the manufacture of reclosable packagings.

The use for the manufacture of reclosable trays is particularly advantageous, and according to a particularly preferred embodiment for the manufacture of the lidding film of these trays.

In the context of the invention, the term “of between x and y” or “ranging from x to y” is understood to mean an interval in which the limits x and y are included. For example, the range “of between 1 and 10” includes in particular the values 1 and 10.

The following examples are given purely by way of illustration of the invention and should not under any circumstances be interpreted in order to limit the scope thereof.

### EXAMPLES

### Ingredients Used

Escorez@ 1310 LC: Nonhydrogenated tackifying resin obtained by polymerization of a mixture of unsaturated aliphatic hydrocarbons having approximately 5 carbon atoms resulting from petroleum cuts. It exhibits a softening temperature of 94° C. (supplier ExxonMobil Chemical) Songnox@ 1010 (supplier Songwon): Primary antioxidant
LDPE, LD0304 grade: low-density polyethylene manufactured in a high-pressure autoclave having an MFI at 190° C. under 2.16 kg of 4 g/10 min (supplier Total)
Koattro@ KT MR06: C2/C4 copolymer having an MFI at 190° C., 2.16 kg, of 1.3 g/10 min and comprising a C₂ ethylene content by weight of approximately 8.3% (supplier LyondellBasell) Terpolymer T: C₂/C₃/C₄ comprising approximately 3% by weight of C2, 9% by weight of C₄, the balance being C₃, and having an MFI at 230° C. under 2.16 kg of 5.50 g/10 min
Regalite@ S1100: Hydrogenated tackifying resin resulting from mixtures of C₉ aromatic hydrocarbons. It exhibits a softening temperature of 100° C. (supplier Eastman Chemical)

### Example 1: Preparation of the Adhesive Compositions

The adhesive compositions (cf table 1) are first prepared in the form of granules of ellipsoidal shape, the major axis and the minor axis of which respectively have a mean dimension of between 1 and 10 mm, preferably between 2 and 6 mm, by mixing their ingredients at a temperature ranging from 150° C. to 200° C. by means of a twin-screw extruder, extrusion through a die and then cutting up the product using a granulating tool of underwater cutting type, then drying and cooling to ambient temperature (23° C.). Table 1 shows percentages by weight.

### Example 2: Preparation of the Three-Layer Films B/A/C Comprising a Layer A of the Composition Of Example 1

This three-layer film is manufactured by means of a continuously operating bubble blowing coextrusion pilot-scale device, in which three extruders are fed:
for one, with the composition of example 1 (composition No. 1, No. 2 or No. 3), and
for the other two, with LDPE.

The parameters of the process are adjusted so as to manufacture a three-layer film consisting:
as layer A, of a layer with a thickness of 15 μm consisting of the composition of example A,
as thin laminatable layer B, of a layer with a thickness of 30 μm consisting of LDPE;
as thin sealable and breakable layer C, of a layer with a thickness of 15 μm also consisting of LDPE.

Several normal parameters were set, namely a degree of radial expansion of the bubble at 3.18, a drawing rate of 7 m/minute and an overall throughput of 11 kg/hour.

The three-layer film thus obtained has a total thickness of 60 μm and a length of 50 m and is packaged in the form of a reel with a machine width of 250 mm.

The different substances were introduced into each extruder, in order to fill the screws and to form the polymer bubble at the outlet of the extrusion die. After purging for 30 minutes, the thicknesses and stability of the bubble controlled, 50 m of film were wound onto mandrels.

### Measurement of the First Opening Strength by T-Peeling at 23° C.

Rectangular test specimens E1 which are 25 cm long and 3 cm wide are cut out from the three-layer film B/A/C obtained abovepreviously.

Furthermore, a PET/PE complex film, consisting of a PET layer with a thickness of 23 μm which is laminated with polyurethane (layer of 2 μm) on a PE layer with a thickness of 50 μm, is used. Rectangular test specimens E2 which are 25 cm long and 3 cm wide are cut out from this complex film.

A test specimen E1 is then placed facing between two test specimens E2, the three test specimens being superimposed, so that the layers B and C of E1 are in contact with the PE layer of E2.

Partial sealing is then carried out using two heating clamping jaws at 130° C. applied under a pressure of 4.6 bar for 1 second, so as to obtain a sealed area of rectangular shape (15 cm in length and 1 cm in width). Said sealed area is arranged in the direction of the length and is located at the center of the assembly of the three superimposed test specimens, so that 5 cm of unsealed films protrude on both sides in the direction of the length, and 1 cm of unsealed films protrude on both sides in the direction of the width.

The strips of loose films located on one and the same side of the assembly of the three test specimens, with respect to the sealed area, are attached:
to a first attachment device (called a jaw) which is connected to the fixed part of a tensile testing apparatus, as regards that of the two strips E2 which is facing the layer C of E1, and
to a second jaw connected to the movable part of said tensile testing apparatus, as regards the other strip E2 and the strip E1.

The fixed and movable parts of the tensile testing apparatus, which is a dynamometer, are located on one and the same vertical axis.

The three strips thus fixed make it possible, by displacement of the jaws of the dynamometer, to stress (or peel) the interface between the layer C of the constituent film B/A/C of E1 and the PE of E2 which faces it.

While a drive mechanism imparts a uniform rate of 300 mm/minute to the movable part, resulting in the peeling of the three sealed test specimens E1 and E2, the ends gradually move along a vertical axis with the formation of an angle of 180°. A force sensor connected to said movable part measures the force withstood by the test specimen thus held. The measurement is carried out in a climate-controlled room maintained at a temperature of 23° C.

The strength obtained is the first opening strength (in N/cm) and is shown in the following table 1.

### Measurement of the Fifth Opening Strength by T-Peeling at 23° C.

The two parts of the preceding test specimen are, after peeling, repositioned facing one another and brought into contact manually. They are then subjected to a pressure exerted using a roller with a weight of 2 kg, with which a to-and-fro movement is carried out along a direction parallel to the length of the test specimen.

A tensile test specimen is thus obtained which is identical in shape to that prepared for the preceding peel test, which is then repeated.

Both stages are carried out four times until the fifth opening strength is obtained. The latter is shown in the following table 1.

### Determination of the Quality of the Rupture at 23° C.

The quality of the rupture was determined by analyzing the shape of the curve of the peel strength of the test specimen as a function of time:

A rupture exhibiting a “stick-slip” phenomenon is characterized by a curve giving the peel strength as a function of time which exhibits peaks and valleys which are characteristic of an opening exhibiting a jerky motion, which creates jolts, which is reflected by an unpleasant sensation for the consumer during the peeling of the adhesive while opening the packaging.

A homogeneous rupture is characterized by a curve giving the peel strength as a function of time which exhibits a substantially uniform plateau which is reflected by a gentle opening of the packaging for the consumer.

TABLE 1

| | | Composition No. | Composition No. | Composition No. |
|---|---|---|---|---|
| | | 1 (comparative) | 2 (invention) | 3 (invention) |
| | C₂/C₃/C₄ Terpolymer | 3.1 | 4.2 | 3.1 |
| | Koattro ® KT MR 06 | 56.6 | 55.5 | 56.6 |
| | Regalite ® S1100 | 39.8 | — | — |
| | Escorez ® 1310LC | — | 39.8 | 39.8 |
| | Songnox ® 1010 SB (AO) | 0.5 | 0.5 | 0.5 |
| | Total | 100 | 100 | 100 |
| Self-adhesive | MFI (g/10 min) | 10.4 | 11.0 | 11.5 |
| composition | | | | |
| (example 1) | | | | |

| | | | No stick-slip | No stick-slip |
|---|---|---|---|---|
| Three-layer film | | Stick-slip | Homogeneous | Homogeneous |
| (example 2) | Rupture quality | observed | opening | opening |
| Three-layer film | Peel strength | 5.9 | 5.0 | 4.4 |
| (example 2) | (N/cm) 1st opening | | | |
| Three-layer film | Peel strength | 0.5 | 0.6 | 0.8 |
| (example 2) | (N/cm) 5th opening | | | |

The compositions 2 and 3 according to the invention advantageously result in a good compromise between the 1^{st} opening peel strength of 5.0 N/cm (composition 2) or 4.4 N/cm (composition 3), satisfactory 5^{th} opening strength (0.6 and 0.8 N/cm) and homogeneous opening without stick-slip phenomenon. On the other hand, the comparative composition No. 1 results in a quality of the rupture which is not satisfactory for the consumer due to observation of a stick-slip phenomenon, and a weak 5^{th} opening strength (0.5 N/cm).

1-19. (canceled)

20. A hot-melt self-adhesive composition comprising:
i. from 40% to 80% by weight of at least one but-1-ene-ethylene copolymer A, said copolymer comprising more than 80% by weight of units derived from but- 1-ene;
ii. from 1.5% to 4.5% by weight of at least one propylene-ethylene-butene copolymer T, said copolymer T comprising more than 50% by weight of units derived from propylene;
iii. at least one nonhydrogenated tackifying resin obtained by polymerization, or copolymerization with an aromatic hydrocarbon, of mixtures of unsaturated aliphatic hydrocarbons having from 4 to 6 carbon atoms resulting from petroleum cuts.

21. The composition as claimed in claim 20, characterized in that it comprises from 45% to 80% by weight of copolymer(s) A, with respect to the total weight of said composition.

22. The composition as claimed in claim 20, characterized in that the copolymer A has a polydispersity index (M_{w}/Mₙ) of less than or equal to 3.

23. The composition as claimed in claim 20, characterized in that the copolymer A has a Shore A hardness of less than or equal to 90.

24. The composition as claimed in claim 20, characterized in that the copolymer A comprises at most 20% by weight of units derived from ethylene.

25. The composition as claimed in claim 20, characterized in that it comprises from 8% to 4.3% by weight of copolymer(s) T, with respect to the total weight of said composition.

26. The composition as claimed in claim 20, characterized in that the copolymer T comprises more than 60% by weight of units derived from propylene.

27. The composition as claimed in claim 20, characterized in that the copolymer T can comprise from 1% to 25% by weight of units derived from ethylene.

28. The composition as claimed in claim 20, characterized in that the copolymer T comprises from 1% to 25% by weight of units derived from butene.

29. The composition as claimed in claim 20, characterized in that the total content of tackifying resin(s) iii) ranges from 18.5% to 58.5% by weight, with respect to the total weight of said composition.

30. The composition as claimed in claim 20, characterized in that it does not comprise a tackifying resin other than the tackifying resin(s) iii).

31. The composition as claimed in claim 20, characterized in that it has a melt flow index (MFI) ranging from 5 to 50 g/10 min.

32. The composition as claimed in claim 20, characterized in that it has a total content of polymers (copolymer A+copolymer T) ranging from 41.5% to 84.5%.

33. The composition as claimed in claim 20, characterized in that it comprises a polymers (copolymer A+copolymer T): tackifying resin(s) iii) ratio by weight ranging from 40:60 to 90:10.

34. The composition as claimed in claim 20, characterized in that it comprises less than 0.1% by weight of styrene block copolymer (SBC), with respect to the total weight of said composition.

35. The composition as claimed in claim 20, characterized in that it is provided in the form of granules of ellipsoidal shape, the mean dimensions of a major axis and of a minor axis of which are as follows:
mean dimension of the major axis of between 1 and 10 mm;
mean dimension of the minor axis of between 1 and 10 mm.

36. A multilayer film comprising two thin layers B and C of thermoplastic material bonded together by an adhesive layer A, characterized in that said layer A consists of the hot- melt self-adhesive composition as defined in claim 20.

37. The multilayer film as claimed in claim 36, characterized in that it comprises five layers consisting of the adhesive layer A, two additional layers D and E and the two thin layers B and C, according to the sequence B/D/A/E/C in which the “/” sign signifies that the faces of the layers in question are in direct contact.

38. Reclosable packagings comprising the multilayer film as defined in claim 36.
